(19) United States
(12) Patent Application Publication
(10) Pub. No.: US 2013/0327483 A1
(43) Pub. Date: Dec. 12, 2013

(54) GROOVED ELECTRIC WELDING SLEEVE

(71) Applicant: Georg Fischer Wavin AG, Schaffhausen (CH)

(72) Inventors: Dirk Petry, Feuerthalen (CH); Juergen Roesch, Lenzkirch (DE); Bastian Luebke, Schaffhausen (CH); Kresimir Pesic, Neuhausen am Rheinfall (CH)

(21) Appl. No.: 13/908,649

(22) Filed: Jun. 3, 2013

(30) Foreign Application Priority Data
Jun. 8, 2012 (EP) 12 171 237.6

(51) Int. Cl. B29D 23/00

(52) U.S. Cl. CPC B29D 23/005
USPC 156/433

(57) ABSTRACT

Electric welding sleeve having a cylindrical sleeve body for the welding of pipes made of thermoplastic material or other weldable plastics, containing at least two heating zones having respectively a plurality of electrically conductive windings and contacts for the supply of the electric current, wherein at least one longitudinally running groove is arranged along the outer surface of the cylindrical sleeve body.

### BACKGROUND OF THE INVENTION

The invention relates to an electric welding sleeve having a cylindrical sleeve body for the welding of pipes made of thermoplastic material or other weldable plastics, containing at least two heating zones having respectively a plurality of electrically conductive windings and contacts for the supply of the electric current.

Mainly in recent years, for weight and corrosion reasons, pipelines made of thermoplastic materials have been increasingly used in pipeline construction, more specifically for the construction of pipeline networks for gas and water supplies, as well as for the conveyance of air, waste water, or else chemicals. The pipelines used are generally made of pressure-resistant plastic. For reasons of quality and efficiency, electric welding sleeves are often used to connect such pipelines. The greater the pipe diameter of the pipelines to be connected, the more effort is required to connect the individual pipeline components. Since, in the case of large pipe cross sections, the gap between pipeline and electric welding sleeve is relatively large, the preconditions for optimal welding are not given. In the case of narrow production tolerances, in which a small gap formation between pipe outer diameter and sleeve inner diameter is achieved, the problem of introducing the pipe into the electric welding sleeve exists. The greater is the diameter of the pipeline, the more are the pipes inclined to ovality and are hence unable to be introduced into the sleeve. Apart from the gap and the ovality of the pipes, there is the further problem of cavitation in the welding zone. In the welding of electric welding sleeves, more specifically in the case of large diameters, bubbles arise in the welding zone following cooling, which bubbles can in some circumstances adversely affect the strength of the weld joint. Bubbles are formed by the volume shrinkage of the melt during hardening of the plastic, or else by the irregular expansion of the melt, in that boundary points first connect to the pipe to be welded and the trapped air therebetween hence no longer has a chance to escape.

Electric welding sleeves which try to eliminate the problem of cavitation by applying a high pressure to the weld are known from the prior art.

EP 0 222 287 B1 discloses a welding sleeve having an armouring which is preferably made of metal and hence possesses a lower coefficient of thermal expansion than the plastics sleeve body. As a result of the lesser expansion of the armouring, a pressure is generated, which pressure allows a good weld.

A drawback with this is that, at low ambient temperatures, the armouring ring, due to the low expansion coefficient, contracts less than the plastics sleeve body. The armouring ring hence detaches from the sleeve body and loses the armouring function, whereby no additional welding pressure is built up.

EP 0 555 684 A1 discloses a welding sleeve which has a reinforcing ring disposed on the outer periphery of the sleeve body. The peripheral stresses triggered by the reinforcing ring generate the pressure which acts radially on the sleeve body and which is necessary for a good weld. During the sleeve cooling operation following the welding, the reinforcing ring also continues to apply pressure to the sleeve body.

A drawback with this invention, and with that which has previously been mentioned, is the complex production method, as well as the high costs. Moreover, it can happen that, as a result of the applied pressure, the distances apart of the windings shift uncontrollably in the axial direction and can lead to exit of the wire.

EP 2 132 024 B1 discloses compensating elements which, by virtue of their conical structural form, are intended to compensate the gap between pipe and sleeve. The compensating elements, starting from the end faces, have slots, which lend flexibility to the compensating element.

A drawback with this is that for such a connection two compensating elements, having respectively two welding zones and a sleeve which applies pressure to the weld, are required. Particularly in the case of large diameters, high material costs, as well as high assembly costs, are incurred.

The object of the invention is to propose an electric welding sleeve which, by virtue of high flexibility of the sleeve body, avoids cavitation by reducing the ring stiffness to a minimum.

### SUMMARY OF THE INVENTION

The foregoing object is achieved according to the invention by the arrangement of a groove along the outer surface of the cylindrical sleeve body.

The effect of the groove is that the ring stiffness of the sleeve body is weakened. Therefore the sleeve body expands during the welding process more than the previous sleeve bodies known from the prior art. Accordingly, however, it also contracts again more during the cooling operation. The sleeve body contracts so strongly that after the welding, at least in the region of the welding zone, it has a smaller outer diameter than prior to installation.

As a result of the inventive electric welding sleeve, the welding operation is a physically different process in comparison to the welding operation with electric welding sleeves which are known from the prior art. In known welding operations, it is attempted by increasing the pressure upon the sleeve body, generally through the use of armourings, to eliminate the cavitation during the cooling operation, or to compress the volume shrinkage of the plastic which hardens from the melt, and the bubbles which are formed thereby.

By contrast, with the inventive electric welding sleeve, the formation of bubbles during the cooling operation is avoided by the high flexibility of the sleeve. The sleeve body expands during the welding, but, as already previously mentioned, also accordingly contracts again. Since the volume shrinkage of the plastic, by virtue of the accompanying movement of the sleeve, does not give rise to any bubbles, no high pressure is required to eliminate or substantially reduce the cavitation.

Moreover, the inventive electric welding sleeve, by virtue of its flexibility, offers the advantage that it can be slipped without difficulty over oval pipe cross sections, since it can be pressed into the appropriate shape in the course of assembly. This, in turn, has the advantage that the gap is small, since the sleeve inner diameter does not have to be much larger than the pipe outer diameter. As a result of the sleeve being pressed into shape, the insertion of an oval pipe is easily possible. By contrast, in the case of a rigid sleeve, the inner diameter must be suitably large to allow the insertion of an oval pipe, whereby a large gap between pipe outer diameter and sleeve inner diameter is formed, which is not an ideal precondition for a good weld. Hitherto, there has been a tendency to assume that the sleeve body would be weakened by the grooving and thus would not achieve the necessary resistance to internal pressure. Since, however, the pipes which are to be joined together are welded in place, they take care of the force absorption in the peripheral direction. In the longitudinal direction, the weakening of the sleeve plays only a subordinate role and can be compensated, if necessary, by a slight increase in wall thickness. A groove can be introduced by mechanical remachining of the sleeve body, for instance by milling. The groove or grooves can also however be provided in the sleeve body already during the injection moulding process or extrusion process, through the use of appropriate moulds of the sleeve body which have a negative of a groove or grooves.

It is advantageous if the sleeve body has a plurality of grooves. The number of grooves on a sleeve body can be between four and 72. The number of grooves is dependent on the size of the sleeve body. That is to say that the diameter plays a part in determining the number of grooves which are disposed on the periphery, as does the wall thickness of the sleeve body. Preferably, the sleeves have 16 or 32 grooves, according to the size of the diameter.

The longitudinally running grooves are preferably distributed evenly along the periphery, whereby a uniform expansion, as well as a subsequently uniform contraction, is obtained.

A groove extends preferably over the entire length of the sleeve body. Alternatively thereto, a groove can extend over a specific portion of the length of the sleeve body. Starting from an end face, the groove extends in the direction of the middle of the sleeve body. The length of the portion over which the groove extends is dependent on the size of the electric welding sleeve or of the sleeve body. Preferably, the portion of the groove extends beyond the middle of the nearer heating zone.

A further embodiment of the invention consists in the grooves extending beyond the middle of the sleeve body, yet not protruding over the complete length of the sleeve body.

Preferably, the grooves which extend from the end face over a portion of the length of the sleeve body terminate in a radius.

It has proved advantageous for grooves which extend over a certain portion to run from both end faces in the direction of the middle of the sleeve body.

Grooves which extend from the two end faces in the direction of the middle are preferably in mutual alignment or the portions are situated on their extension.

Alternatively thereto, the option exists that the portions of the grooves which extend from both end faces in the direction of the centre of the sleeve and in some circumstances pass beyond the middle are not in mutual alignment. That is to say that they run in mutually offset arrangement on the periphery.

It has been shown that it is advantageous if a groove has a depth which lies within the range of 50-90% of the wall thickness. The depth of a groove is dependent, however, on the size of the electric welding sleeve, as well as the wall thickness. The groove should not exceed the depth of 95% of the wall thickness, since the sleeve body would otherwise become too weak.

Different strength levels of sleeve bodies can easily be realized by producing a different depth of the grooves on the respective sleeve body.

The option exists of arranging around the electric welding sleeve an armouring ring which optimizes the strength of the sleeve, wherein the ring can be formed from at least two shell parts which are to be connected to each other, which shell parts are mutually clamped together or clamped to each in order to produce additional strength.

### BRIEF DESCRIPTION OF THE DRAWINGS

Illustrative embodiments of the invention are described with reference to the figures, though the invention is not just limited to the illustrative embodiments, wherein:

FIG. 1 shows a longitudinal section through an inventive electric welding sleeve in which the grooves extend over the entire length of the sleeve body,

FIG. 2 shows a perspective view of an inventive electric welding sleeve in which the grooves extend over the entire length of the sleeve body,

FIG. 3 shows a longitudinal section through an inventive electric welding sleeve in which the grooves extend over a specific portion from the end faces in the direction of the middle of the sleeve body,

FIG. 4 shows a perspective view of an inventive electric welding sleeve in which the grooves extend in alignment over a specific portion from the end faces in the direction of the middle of the sleeve body,

FIG. 5 shows a perspective view of an inventive electric welding sleeve in which the grooves extend in non-alignment over a specific portion from the end faces in the direction of the middle of the sleeve body,

FIG. 6 shows a longitudinal section of an inventive electric welding sleeve having a reinforcing ring, and

FIG. 7 shows a longitudinal section of an inventive electric welding sleeve in which the grooves were jointly introduced during the injection moulding process.

### DETAILED DESCRIPTION

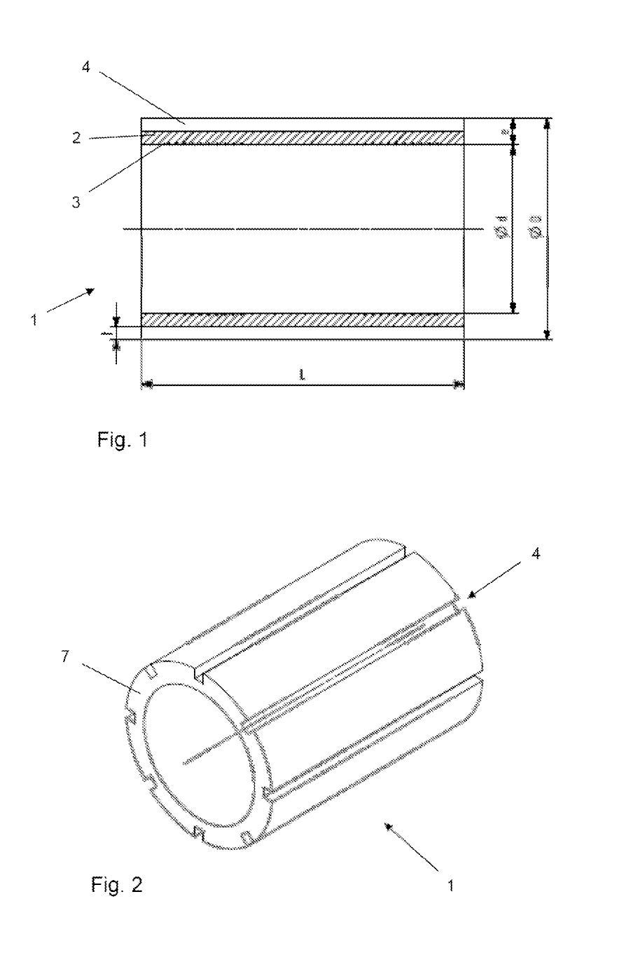

FIG. 1 shows an electric welding sleeve 1 for the connection of plastics pipelines. The sleeve body 2 is produced from weldable plastic, preferably from a thermoplastic material. The electric welding sleeve 1 has at least two heating zones 3, which are connected by contacts 6 to the electric current in order to heat the heating zones 3 for the welding of the pipes to the electric welding sleeve 1.

The electric welding sleeve 1 depicted in FIG. 1 has grooves 4, which extend over the complete length L of the sleeve body 2. As a result of the grooves 4, the ring stiffness of the electric welding sleeve 1 is deliberately weakened, whereby the sleeve 1, during the welding, expands with the volume of the plastic to be welded. During the cooling of the weld, the volume of the plastic of the weld seam diminishes. By virtue of the flexibility of the sleeve body 2, as a result of the incorporated grooves 4, the size or the diameter of the sleeve body 2 likewise diminishes. The formation of bubbles can thereby be avoided, since no cavities can be formed as a result of volume shrinkage, as is known in the case of electric welding sleeves from the prior art. In the present invention, the sleeve body 2 contracts during the cooling just as it has previously expanded during the warming. As a result of the volume shrinkage, the sleeve body 2 contracts to a diameter d, D which is generally smaller than that of the electric welding sleeve 1 which is yet to be installed or welded in place. In this case the width of the groove 4 reduces.

The number of grooves 4 which are distributed over the periphery of the sleeve body 2 is dependent on the size of the sleeve 1, that is to say on the inner and outer diameter d, D and the wall thickness e. Preferably, the number of grooves 4 which are distributed on the periphery lies between four and 72. It has been shown that electric welding sleeves 1 having a number of grooves 4 between 16 and 32 are most suitable.

The depth t of the grooves 4 is likewise dependent on the size or the diameters d, D in dependence on the wall thickness e of the electric welding sleeve 1. Preferably, the depth t lies within the range of 50-90% of the wall thickness e. However, the groove 4 should not exceed the depth of 95% of the wall thickness e. FIG. 2 shows an inventive electric welding sleeve 1 which has eight grooves 4 over the complete length L of the sleeve body 2. Preferably, the grooves 4 are arranged regularly along the periphery. By virtue of the regular arrangement, a uniform expansion and a uniform contraction of the sleeve body are ensured.

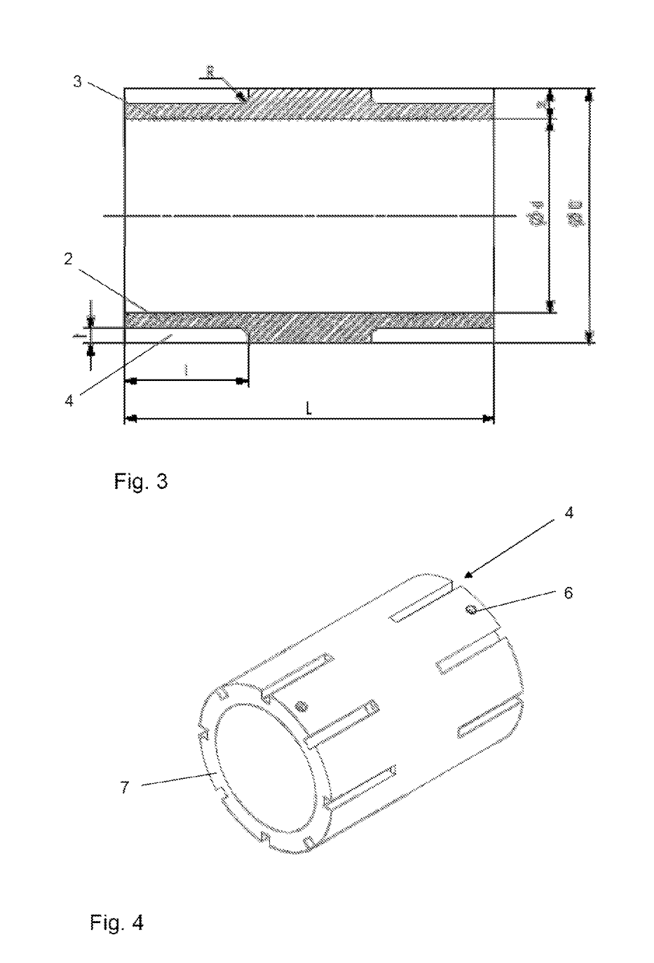

FIG. 3 shows an electric welding sleeve 1 in which the grooves 4 respectively extend from the end face 7 in the direction of the middle. The grooves 4 extend over a portion I having a length which depends on the size of the electric welding sleeve 1. Preferably, the portion I extends over the middle of the respective heating zone 3 which is located on that same side of the sleeve body from which the grooves extend, or over the middle of the nearer heating zone 3.

For the avoidance of stress peaks or subsequent stress cracks, on the portion end of the portions I of the grooves 4 is respectively found a radius R. The radius R serves to terminate the grooves 4 and is advantageously large in dimension.

The portions I which extend from both end faces 7 in the direction of the middle of the sleeve body 2 are preferably aligned and are thereby situated in their own extension, as shown in FIG. 4.

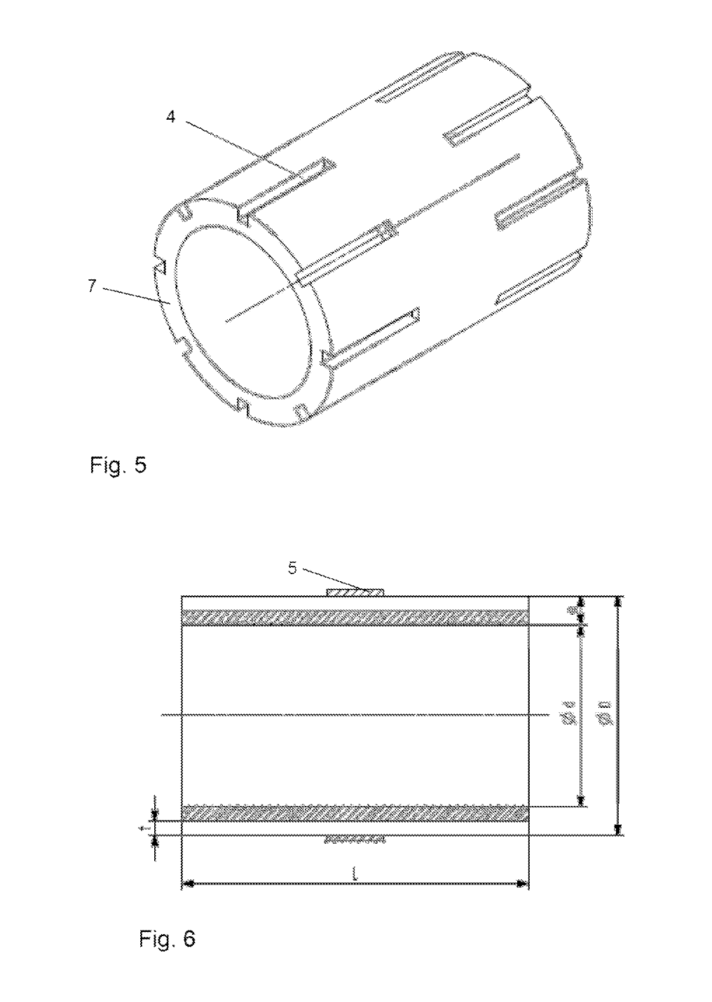

A further possible embodiment of an inventive electric welding sleeve 1 is shown in FIG. 5, in which the grooves 4 or the portions I are arranged offset, so that they are not in mutual alignment. Alternatively, the grooves 4 can also protrude beyond the middle of the sleeve body 2 (not represented here).

FIG. 6 shows an inventive electric welding sleeve 1 in which an armouring ring 5 is fitted as reinforcement in order to increase the strength after the pipes have been welded together. The armouring ring 5 is preferably formed from two shell parts which are clamped together, though more than two shell parts or a one-piece ring are also conceivable. The ring 5 or the shell parts for the formation of the armouring ring 5 can be made of the same material as the sleeve body 2 or else of other materials, for example of plastic or metal.

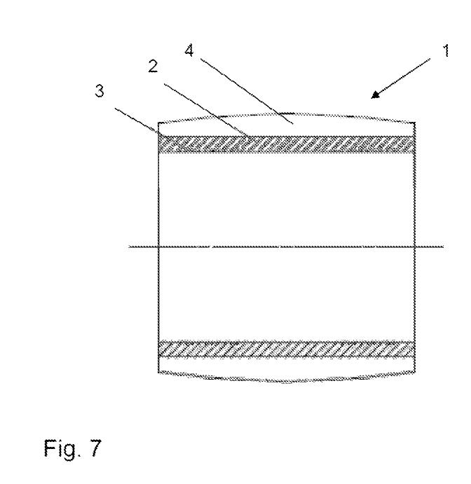

In FIG. 7 is depicted an inventive electric welding sleeve 1 produced by injection moulding. That is to say that the grooves 4 have likewise been introduced during the injection moulding process by an appropriate mould, so that reworking in terms of milling of the grooves 4 is no longer necessary. Due to the manufacturing process, the sleeve 1 does not have a cylindrical outer shape but is slightly convex or has a bulged shape.

1. An electric welding sleeve comprising a hollow cylindrical sleeve body having an interior surface adapted to receive plastic pipes, wherein the interior surface has at least two heating zones each having a plurality of electrically conductive windings connected by contacts to a supply of the electric current, wherein at least one longitudinally running groove is arranged along an outer surface of the hollow cylindrical sleeve body.

2. An electric welding sleeve according to claim 1, wherein the hollow cylindrical sleeve body has at least four grooves arranged along the outer surface.

3. An electric welding sleeve according to claim 2, wherein the at least four grooves are arranged longitudinally at equal intervals along the outer surface.

4. An electric welding sleeve according to claim 1, wherein the at least one groove extends over the entire length (L) of the sleeve body.

5. An electric welding sleeve according to claim 1, wherein the groove extends from an end face of the cylindrical sleeve body in a direction forward the middle of the sleeve body over a portion (I) of the sleeve body.

6. An electric welding sleeve according to claim 5, wherein the portion (I) of the groove extends over the middle of the nearer of the at least two heating zones.

7. An electric welding sleeve according to claim 5, wherein the portion (I) of the groove extends over the middle of the sleeve body.

8. An electric welding sleeve according to claim 5, wherein the sleeve body has two end faces and grooves extend from both end faces of the sleeve body in a direction toward the middle.

9. An electric welding sleeve according to claim 8, wherein the grooves which extend from both end faces in the direction of the middle are in mutual alignment.

10. An electric welding sleeve according to claim 8, wherein the grooves which extend from both end faces are mutually offset.

11. An electric welding sleeve according to claim 1, wherein the groove has a maximum depth (t) of 95% of the wall thickness (e).

12. An electric welding sleeve according to claim 1, wherein the groove has a depth (t) of 50-90% of the wall thickness (e).

13. An electric welding sleeve according to claim 1, wherein an armouring ring is disposed on the sleeve body.

14. An electric welding sleeve according to claim 13, wherein the armouring ring is formed by at least two shell parts.
